(19) United States
(12) Patent Application Publication
(10) Pub. No.: US 2010/0085397 A1
(43) Pub. Date: Apr. 8, 2010

(54) PRINTING APPARATUS AND PRINTING METHOD

(75) Inventors: Ryoichi TANAKA, Shiojiri-shi (JP); Teruaki KAIEDA, Matsumoto-shi (JP); Hirokazu NUNOKAWA, Matsumoto-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/572,520

(22) Filed: Oct. 2, 2009

(30) Foreign Application Priority Data
Oct. 3, 2008 (JP) 2008-258357

(51) Int. Cl. B41J 29/38

(52) U.S. Cl. 347/14

(57) ABSTRACT

A printing apparatus includes a transporting unit that transports a printing medium in a transport direction. A print head group has print heads disposed at an interval in the transport direction. Each of the print heads has ink ejecting nozzles in a range substantially perpendicular to the transport direction, including a margin area outside an image forming area in the printing medium. Image detection units correspond to the print heads except for at least the uppermost upstream side print head in the transport direction. A printing control unit controls the print heads so that the print heads eject ink on the printing medium. The uppermost upstream side print head prints a reference timing pattern on the margin area. A print head corresponding to the detection unit prints a checking timing pattern when the reference timing pattern is detected, thereby controlling the ink ejection timing of the printing apparatus.

### BACKGROUND

1. Technical Field

The present invention relates to a printing apparatus and a printing method.

2. Related Art

A printer including recording heads (sometimes, referred to as line type heads) where a plurality of nozzles are aligned in a direction (width direction of a printing medium) perpendicular to a moving direction of the printing medium to cover the maximum recording width of the printing medium is fixed to an apparatus main body to eject ink is proposed (refer to Patent Document JP-A-6-183029). According to the configuration, movement of the recording heads is not needed, so that the printing can be performed simply by the movement of the printing medium. Therefore, the printing time can be reduced in comparison with a printer using so-called serial heads.

In such a printer including the line type heads, a plurality of the line type heads (for example, the line type heads for inks used by the printer) may be disposed at a predetermined interval in the transport direction of the printing medium, and the image of each color may be printed by ejecting ink in the order of the line type heads which the transported printing medium passes through. According to the printer having the configuration, images printed by the line type heads are sequentially overlapped, so that a color image in multi-color printing is finally output.

In a case such the above where the printing is sequentially performed by a plurality of the line type heads, whole or local shifting of the positions of the images printed by the line type heads (for example, a variation between the image printed by the head ejecting black ink and the image printed by the head ejecting cyan ink) causes a deterioration in image quality. Therefore, in order to secure the quality of the printing resultant (for example, to-be-distributed published material) the user of the printer having the configuration needs to check whether or not there is a variation in the position between the images printed by the line type heads in the printing resultant. However, in the checking method where the user observes the details of the printed image, there is a heavy burden on the user, difficulty in maintaining a constant quality in the checking result, and a limitation on a checking accuracy.

### SUMMARY

An advantage of some aspects of the invention is to provide a printing apparatus and a printing method capable of obtaining a printing resultant by which the quality of an image can be easily checked.

According to an aspect of the invention, there is provided a printing apparatus comprising: a transporting unit that transports a printing medium in a predetermined transport direction; a print head group having a configuration where a plurality of print heads, each of which has a plurality of ink ejecting nozzles in a range substantially perpendicular to the transport direction including a margin area outside a predetermined image forming area in the printing medium, are disposed at a predetermined interval in the transport direction; image detection units that are disposed corresponding to the print heads except for at least the uppermost stream side print head in the transport direction among the plurality of the print heads; and a printing control unit that controls the print heads so that the print heads eject ink on the transported printing medium, wherein the uppermost stream side print head prints on the margin area a reference timing pattern indicating an ink ejection timing for the image forming area by the uppermost stream side print head, and when an ink ejection timing for the image forming area by the print head corresponding to the image detection unit that detects the reference timing pattern is controlled based on the detection of the reference timing pattern by the image detection unit, the print head corresponding to the image detection unit that performs the detection prints on the margin area a checking timing pattern indicating the ink ejection timing by the print head corresponding to the image detection unit that performs the detection.

According to the invention, the relative positional relationship between the reference timing pattern and the checking timing pattern printed on the margin area of the printing medium represents the positional relationship of the printing results of the print heads except for the uppermost stream side print head with respect to the printing result of the uppermost stream side print head. Therefore, a user does not observe a desired image printed on the image forming area but the reference timing pattern and the checking timing pattern printed on the margin area, so that the user can more easily determine the quality of the printing resultant (small variation between the images printed by the print heads) with high accuracy.

The plurality of the print heads may eject different color inks. According to the configuration, the reference timing pattern and the checking timing pattern are printed on the margin area with the colors corresponding to the print heads of printing thereof. Therefore, the user can easily check whether or not the printed positions of the colors are correct by observing the reference timing pattern and the checking timing pattern.

Before the reference timing pattern or the checking timing pattern is printed, each print head may perform preliminary printing by ejecting ink on an area in the vicinity of a front end of the printing medium directed in the transport direction downstream side in the margin area. According to the configuration, since each of the print heads performs the preliminary printing so as to eliminate ejection defects in the nozzles that are used to print the reference timing pattern or the checking timing pattern, a reference timing pattern or a checking timing pattern that more accurately indicates the ink ejection timing of each print head can be printed.

The uppermost stream side print head may print a ruled line substantially perpendicular to the transport direction at a ratio of one time per predetermined number of pixels as the reference timing pattern, and the print heads except for the uppermost stream side print head may eject ink so as for the ink landing positions to be substantially equal to each other in an extension line of the ruled line, so that the checking timing pattern is printed. According to the configuration, by checking whether or not the checking timing pattern is printed in the extension line of the ruled line (reference timing pattern) in the margin area, it is possible to easily determine the degree of a variation between the images printed by the print heads with high accuracy.

Various detailed configurations of the checking timing pattern or the reference timing pattern that is printed on the margin area may be considered. As an example, the print heads except for the uppermost stream side print head may eject ink at a predetermined interval between the ink droplets ejected by the same print head in the direction substantially perpendicular to the transport direction, so that the checking timing pattern where ink droplets ejected by different print heads are alternately adjacent to each other is printed. In addition, the print heads except for the uppermost stream side print head may eject ink so as for a predetermined number of ink droplets ejected by the same print head to be continuous with each other in the direction substantially perpendicular to the transport direction, so that a checking timing pattern where a plurality of lines formed by ink ejection of the print heads are substantially continuous with each other is printed. In addition, the ruled line may be printed and a reference timing pattern constructed with ink droplets ejected at a predetermined interval may be printed at positions separated from the ruled line in the extension line of the ruled line, so that the checking timing pattern is printed in an area between the ink droplets ejected at the predetermined interval. According to the configurations, the user can easily check the relative positional relationship between the reference timing pattern and the checking timing pattern in the margin area.

Hereinbefore, although the technical idea of the invention is described by using the printing apparatus, the invention of a printing method including processes that are executed by components included in the aforementioned printing apparatus or the invention of a printing process program of which functions corresponding to the components included in the aforementioned printing apparatus are executed by a computer can be implemented. In addition, the printing apparatus may be a single-body apparatus, or the printing apparatus may be configured with a plurality of apparatuses (for example, a printer including a transporting unit and print heads and a computer as a controller of the printer).

### BRIEF DESCRIPTION OF THE DRAWINGS

The invention will be described with reference to the accompanying drawings, wherein like numbers reference like elements.

FIG. 1 is a schematic view showing a configuration of a printer.

FIG. 2 is a plan view showing a nozzle formation surface side of a head unit.

FIG. 3 is a plan view showing a nozzle formation surface side of a print head.

FIG. 4 is a block diagram showing an electrical configuration of a printer.

FIG. 5 is a timing chart showing ejection control of an uppermost stream side print head.

FIG. 6 is a top plan view showing a printer that performs printing on a sheet.

FIGS. 7A and 7B are views showing an example of a reference timing pattern and a checking timing pattern that are printed on a margin area.

FIGS. 8A and 8B are views showing an example of a reference timing pattern and a checking timing pattern that are printed on a margin area.

FIG. 9 is a timing chart showing ejection control based on a reference timing pattern.

FIGS. 10A and 10B are views showing another example of a reference timing pattern and a checking timing pattern that are printed on a margin area.

FIG. 11 is a view showing another example of a reference timing pattern and a checking timing pattern that are printed on a margin area.

FIGS. 12A and 12B are views showing another example of a reference timing pattern and a checking timing pattern that are printed on a margin area.

FIGS. 13A and 13B are views showing another example of a reference timing pattern and a checking timing pattern that are printed on a margin area.

FIGS. 14A and 14B are views showing a reference timing pattern and a checking timing pattern that are printed on a margin area as a comparative example with respect to FIG. 10.

FIG. 15 is a view showing a reference timing pattern and a checking timing pattern that are printed on a margin area as a comparative example with respect to FIG. 11.

FIG. 16 is a view showing an example of a preliminary printing area on which preliminary printing is performed.

### DESCRIPTION OF EXEMPLARY EMBODIMENTS

Hereinafter, embodiments of the invention will be described with reference to the drawings.

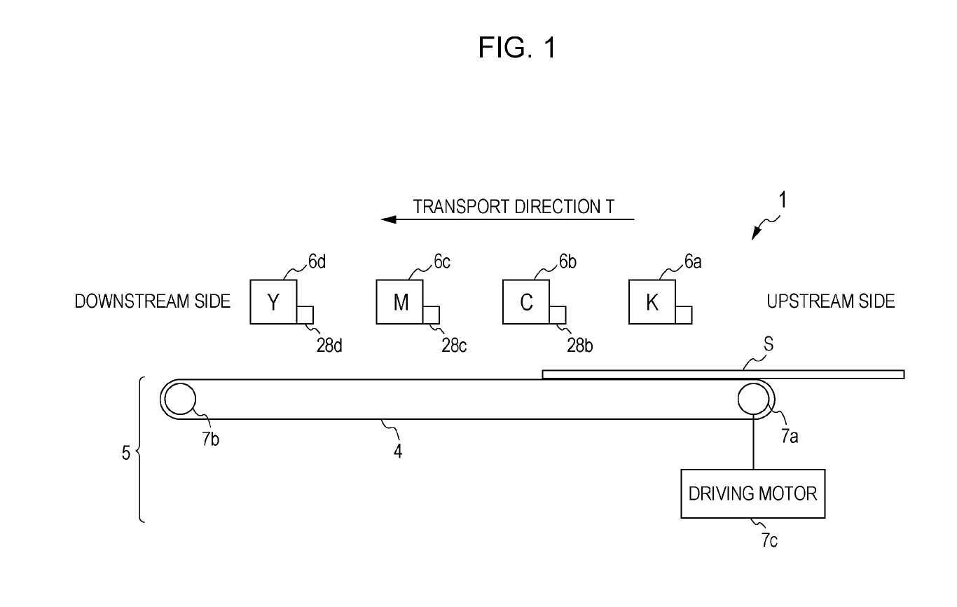

FIG. 1 schematically shows a portion of a configuration of an ink jet printer 1 (hereinafter, simply referred to as a printer) according to the embodiment. FIG. 1 shows the configuration of the printer 1 as viewed from the side thereof. The printer 1 corresponds to an example of a printing apparatus according to the invention. In the printer 1, a plurality of print heads 6a, 6b, 6c, and 6d (print head group) are disposed at a predetermined interval in a transport direction (direction T indicated by the arrow in the figure) of a sheet S (printing medium). In the embodiment, the print heads 6a to 6d are fixed inside of the printer 1.

The print heads 6a to 6d correspond to a plurality of ink colors used by the printer 1. For example, the print head 6a disposed at the transport direction uppermost stream side is used to eject a black (K) ink, and the print heads 6b to 6d disposed at the transport direction downstream side of the print head 6a are used to eject a cyan (C) ink, a magenta (M) ink, and a yellow (Y) ink, respectively. A plurality of nozzles 16 for ejecting the supplied inks is formed on lower surfaces (nozzle formation surface) of the print heads 6a to 6d to be extended over the entire width of the maximum printable area (area including an image forming area A1 and a margin area A2) of the sheet S in a direction (direction normal to a paper surface in FIG. 1) substantially perpendicular to the transport direction of the sheet S. In other words, in the embodiment, the printer 1 is configured as a so-called full line head type printer. The print heads 6a to 6d are connected to ink cartridges (not shown) for storing different color inks. During the printing, the inks stored in the ink cartridges are supplied to the print heads 6a to 6d at any time in the state that the pressures thereof are adjusted to be predetermined pressures.

In the printer 1, a transporting mechanism 5 (transporting unit) for transporting the sheet S in the transport direction is disposed under the print heads 6a to 6d. The transporting mechanism 5 includes, for example, a driving roller 7a, a driven roller 7b, a transporting belt 4 that is suspended by the rollers 7a and 7b, and a driving motor 7c for driving and rotating the driving roller 7a. In the transporting mechanism 5, in the state where the transporting belt 4 is suspended by the driving roller 7a and the driven roller 7b, the driving roller 7a is rotated by the driving motor 7c to drive the transporting belt 4, so that the sheet S mounted on the transporting belt 4 is transported from the upstream side to the downstream side in the transport direction. As a result, the sheet S sequentially passes under the print heads 6a to 6d.

Although not shown, a feed tray that receives a before-printing sheet S may be disposed at the transport direction upstream side of the transporting mechanism 5, and a discharge tray that receives an after-printing sheet S may be disposed at the transport direction downstream side of the transporting mechanism 5. In this configuration, when the sheet S is transported under the nozzle formation surface of the uppermost stream side print head 6a by the transporting mechanism 5, the printer 1 starts ink ejection on the sheet S by the print head 6a. After that, the printer 1 sequentially starts ink ejection on sheet S by the print heads 6b to 6d at the timing when the sheet S is transported under the nozzle formation surfaces of the print heads 6b to 6d.

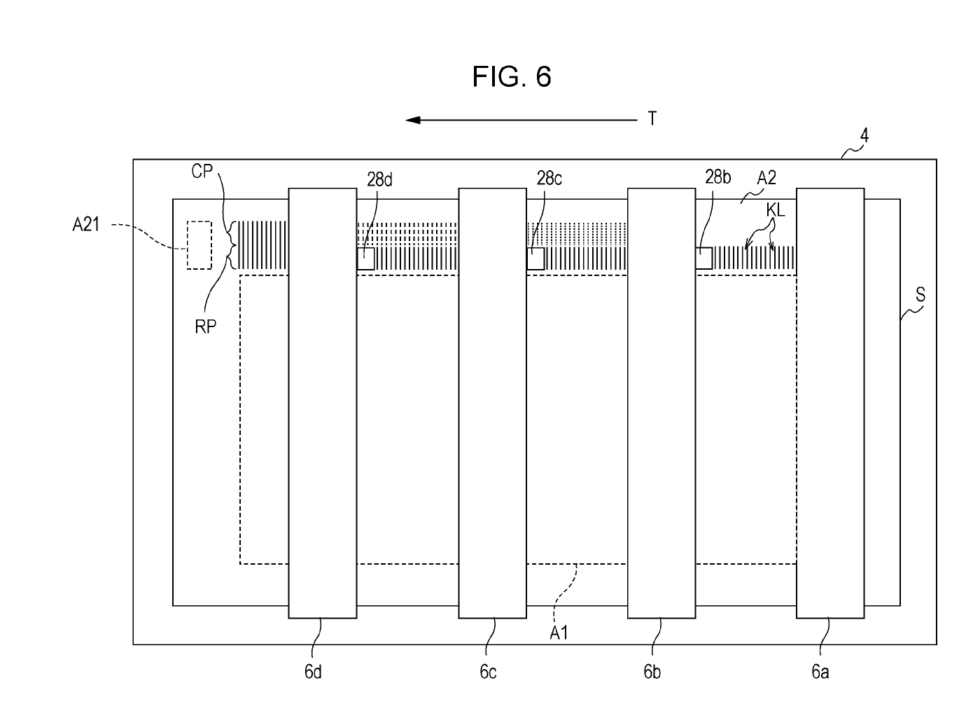

As a result, the user's desired printing result of the CMYK multi-color printing can be represented in a portion of the image forming area A1 of the sheet S passing the lowermost stream side print head 6d. In addition, in the embodiment, the printer 1 allows the print head 6a to print the reference timing pattern RP and the print heads 6b to 6d except for the print head 6a to print the checking timing pattern CP on the margin area A2 of the sheet S (refer to FIG. 6). The image forming area A1 denotes an area where the user's desired image is formed by landing ink on the sheet S that is positioned at the defined position at which the sheet S is properly positioned in the transport path. The margin area A2 denotes an area like a frame outside the image forming area A1. The printing of the reference timing pattern RP and the checking timing pattern CP will be described later in detail. In addition, in the printer 1, the order of installation of the print heads 6a to 6d (the order of inks ejected on the sheet S), the kind of the inks ejected by the print heads, and the number of print heads are not limited to the aforementioned example.

In addition, as shown in FIG. 1, the print heads 6b to 6d except for the uppermost stream side print head 6a include the photosensors 28b to 28d as the image detection units, respectively. Each of the photosensors 28b to 28d is disposed at a position corresponding to a passing range of at least the reference timing pattern RP. As described later, the photosensors 28b to 28d are installed so as to detect the reference timing pattern RP that is printed on the margin area A2.

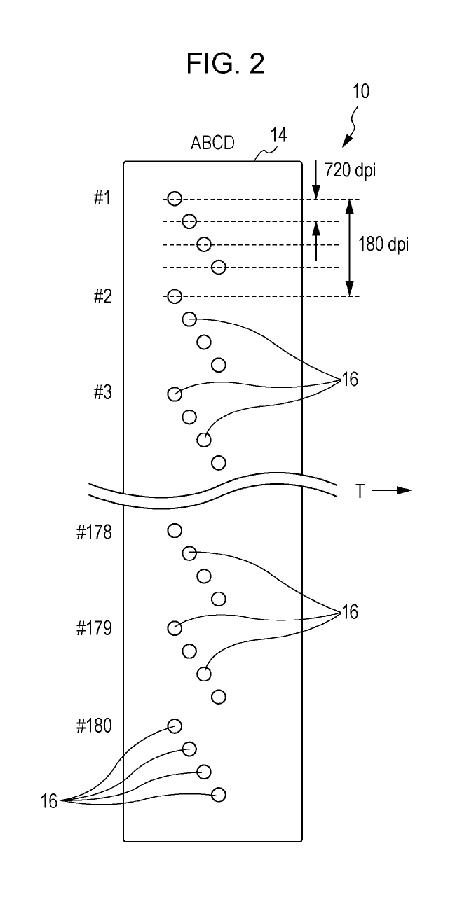

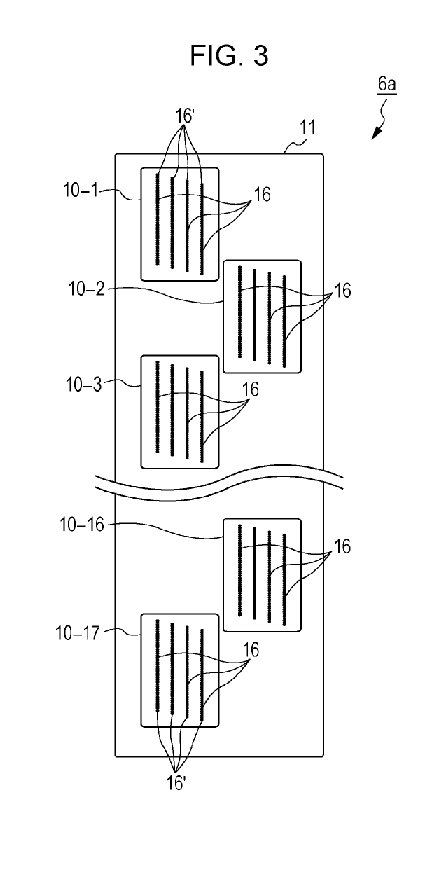

FIG. 2 is a plan view showing an example of a nozzle formation surface (nozzle formation surface 14) of a head unit 10 included in the print head 6a. FIG. 3 is a plan view showing an example of a nozzle formation surface side of the print head 6a. Since the configurations of the print heads 6a to 6d are the same, only the example of the print head 6a is described. In the example of FIG. 2, in the nozzle formation surface 14 of the head unit 10, nozzle columns are configured by aligning the nozzles 16 in a plurality of columns in the direction (nozzle column alignment direction) substantially perpendicular to the transport direction of the sheet S. A plurality of nozzles columns A to D (for example, four columns) are formed in the transport direction. One nozzle column of the head unit 10 is constructed with 180 nozzles 16 that are opened at a pitch of 180 dpi. Each nozzle column is disposed in the state where the position thereof is relatively shifted in the nozzle column alignment direction so that the pitch in the nozzle column alignment direction with respect to the adjacent nozzle columns is 720 dpi. Therefore, the head unit 10 according to the embodiment includes a sum of 720 nozzles 16 at the pitch of 720 dpi as viewed in the nozzle column alignment direction.

In the example of FIG. 3, in the print head 6a, a plurality of the head units 10 are disposed to a main-body case 11 in a two-stage zigzag shape at the alignment interval where the nozzles 16 are aligned at 720 dpi as a whole. The print head 6a is a head unit group where the nozzles 16 of the plurality of the head units 10 are disposed in a range corresponding to the maximum printing area in the width of the sheet S as a whole. In the example of FIG. 3, since the print head 6a includes 17 head units 10 that are aligned in the nozzle column alignment direction, the print head 6a has a sum of 12240 nozzles 16 at the pitch of 720 dpi in the nozzle column alignment direction. In addition, the plurality of the head units 10 is not necessarily disposed in the zigzag shape. For example, in the print head 6a, the plurality of the head units 10 may be aligned in a straight shape in the nozzle column alignment direction.

Among the nozzles 16 disposed to the print head 6a, the plurality of the nozzles 16 at two end portions in the nozzle column alignment direction serve as preliminary nozzles 16′ corresponding to the margin area A2 of the sheet S. There is no difference between the structures of the nozzles 16 and the preliminary nozzles 16′. In addition, the number of nozzles 16 serving as the preliminary nozzles 16′ varies with the size of the sheet S or the size of the set image forming area A1 (or margin area A2). Hereinafter, if not specifically described, the nozzles 16 and the preliminary nozzles 16′ are collectively referred to as the nozzles 16. In addition, inside the print head 6a, components needed for ejecting ink (sometimes, referred to as ink droplets or dots) from each nozzle 16 are disposed, such as a pressure chamber (for each nozzle 16) connected to each nozzle 16, a piezoelectric device for deforming each pressure chamber, and a fluid path for introducing ink into each pressure chamber.

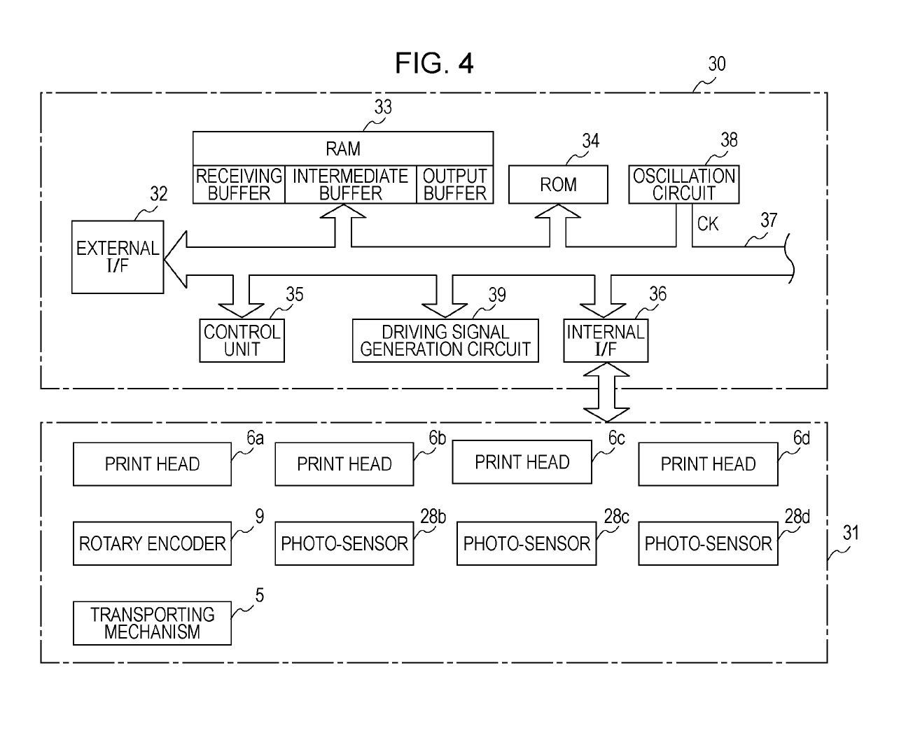

FIG. 4 is a block diagram showing an electrical configuration of the printer 1. The printer 1 includes a printer controller 30 and a print engine 31. The printer controller 30 includes an external interface (external I/F) 32 that receives printing data and the like from an external apparatus such as a host computer (not shown), a RAM 33 that stores various data, a control unit 35 that is constructed with a CPU or the like to electrically control components, a ROM 34 that stores various control routines, font data, and graphic functions executed by the control unit 35, various procedures, various data, and the like, and an internal interface (internal I/F) 36 that is used to transmit the serial data, the driving signal COM, and the like to the print engine 31. These components are connected to each other via an internal bus 37. In addition, the printer controller 30 includes an oscillating circuit 38 that generates a clock signal CK and a driving signal generating circuit 39 that generates a driving signal COM that is to be supplied to the print heads 6a to 6d. The printer controller 30 or the control unit 35 is a unit that controls operations of the print engine 31. The printer controller 30 or the control unit 35 is an example of the printing control unit.

In the embodiment, the printing data denotes, for example, multi-gradation RGB (red, green, blue) image data that are transmitted from an external apparatus to the printer 1. In addition, the printing data are data that represent the user's desired image (document, a picture of nature, CG, or the like) that are printed in the image forming area A1. The serial data denote data that are expanded based on the printing data and the like to be transmitted to the print heads 6a to 6d. The RAM 33 is used as a receiving buffer, an intermediate buffer, an output buffer, a work memory (not shown), or the like. The printing data that the external I/F 32 receives from the external apparatus are temporarily stored in the receiving buffer. The control unit 35 expands the printing data to the serial data corresponding to the nozzles 16 of the print heads 6a to 6d to transmit the serial data to the print heads 6a to 6d. In this case, control unit 35 reads out the printing data from the receiving buffer, converts the printing data to intermediate code data, and stores the intermediate code data in the intermediate buffer. In addition, the control unit 35 analyses the intermediate code data read out from the intermediate buffer and expands the intermediate code data to the serial data for each dot size with reference to the font data, the graphic function, or the like in the ROM 34. In the embodiment, the serial data is constructed with two-valued serial data (raster data) that designate the ejection or non-ejection of each nozzle 16.

The serial data that are expanded based on the printing data are stored in the output buffer of the RAM 33. When the serial data corresponding to one line (the entire nozzles of the print head) are stored, the serial data are serially transmitted through the internal I/F 36 to the print head. In the embodiment, the print heads that are transmission sources are different according to the colors designated by the serial data. For example, the serial data corresponding to the color K are transmitted to the print head 6a. In addition, since each of the print heads 6a to 6d is constructed with a plurality of the head units 10, the serial data are divided into a plurality of block data corresponding to the head units 10-1 to 10-17 to be transmitted to the corresponding head units 10. The print heads 6a to 6d perform ink ejection operations of the nozzles 16 based on the received serial data.

The print engine 31 is constructed with an electrical driving system of the print heads 6a to 6d or the transporting mechanism 5. In addition, the print engine 31 includes photosensors 28b to 28d provided to the corresponding print heads 6b to 6d and a rotary encoder 9. The rotary encoder 9 includes, for example, a disk-shaped scale plate that is rotated together with a rotation shaft of the driving motor 7c (refer to FIG. 1) and a photo interrupter (sensor constructed with a light emitting device and a light receiving device) that detects a plurality of slits (Slits 8) formed at a predetermined width and interval along the circumference of the scale plate. The rotation amount of the driving motor 7c has a predetermined relationship with the rotation amount of the driving roller 7a (movement amount of the transporting belt 4). When the scale plate is rotated together with the driving motor 7c and the driving roller 7a, the photo interrupter outputs the detection signal (encoder pulse EP) of which the level (H or L level) is changed according to the detection or non-detection of the slits 8 from the light receiving device to the control unit 35.

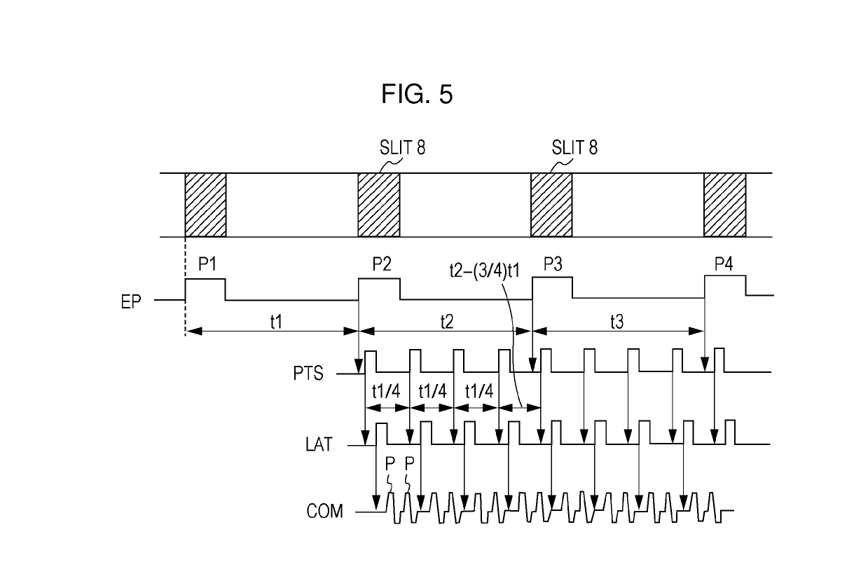

FIG. 5 is a timing chart of ejection control for the uppermost stream side print head. In the embodiment, as shown in FIGS. 5A and 5B, during the time duration when the photo-interrupter detects the slit 8 (the time duration when the light from the light emitting device passes through the slit 8), the encoder pulse EP output by the light receiving device is at the H level. Therefore, the encoder pulse EP, of which the period is synchronized with the moving speed of the transporting belt 4 (the transporting speed of the sheet S), is output from the rotary encoder 9. If the speed of the transporting belt 4 is constant, the encoder pulse EP is also output in a constant period. As described later, in the embodiment, the printer controller 30 controls the timing of the ink ejection of the uppermost stream side print head 6a on the sheet S with reference to the encoder pulse EP. In addition, the rotary encoder 9 is merely a unit for acquiring the moving amount of the transporting belt 4. Therefore, in the printer 1, as the unit for acquiring the moving amount of the transporting belt 4, as well as the rotary encoder 9, for example, a linear encoder which outputs a pulse signal based on a detection result of a stripe-shaped scale pattern formed at a constant interval in the transporting belt 4 may be used.

The driving signal generating circuit 39 generates the driving signals COM under the control of the control unit 35. As shown in FIG. 5E, the driving signals COM are a series of signals that are constructed with driving pulses P disposed within one ejection period (one recording period). When the driving pulse P is applied to the piezoelectric device of each nozzle 16, the ink is ejected from the nozzle 16. The application of the driving pulse P is performed according to the value “1” in the serial data that indicates the ejection (dot one). In addition, the application of the driving pulse is not performed according to the value “0” that indicates the non-ejection (dot off).

As described above, in the printer 1, while the sheet S is transported by driving the transporting mechanism 5, the ink for each color is caused to land on the sheet S by the print heads 6a to 6d, so that the image is recorded. In such a configuration, there may be a mechanical error in the transporting mechanism 5 or the like, so that a variation (non-uniformity) in the speed of the transporting belt 4 may occur. Therefore, in the case where no countermeasures are taken, variation of the ink landing positions of the sheet S among the print heads 6a to 6d may occur. As a result, image quality of the printing resultant may be deteriorated.

The printer controller 30 allows the uppermost stream side print head 6a to print the reference timing pattern RP that designates the K ink ejection timing for the image forming area A1 in the margin area A2 of the sheet S. In addition, in each of the print heads 6b to 6d at the transport direction downstream side of the print head 6a, the reference timing pattern RP is detected by each of the photosensors 28b to 28d thereof, and the ink ejection timings of the print heads 6b to 6d are controlled (adjusted) based on the detection, so that the variation in the ink landing positions of the sheet S can be prevented. Moreover, the printer controller 30 allows the print heads 6b to 6d to print the checking timing pattern CP that designates the ink ejection timings of the print heads 6b to 6d that are adjusted based on the detection of the reference timing pattern RP in the margin area A2.

Firstly, the control of the ink ejection of the uppermost stream side print head 6a is described.

As described above, the encoder pulse EP from the rotary encoder 9 is output to the control unit 35. The control unit 35 generates timing pulses PTS (refer to FIG. 5C) from the encoder pulse EP. The timing pulse PTS is a signal that designates an output timing of the driving signal COM (refer to FIG. 5E) that is generated by the driving signal generating circuit 39. In other words, the driving signal generating circuit 39 outputs the driving signal COM every time the timing pulse PTS is received. In addition, a serial clock signal CK is generated based on the timing pulse PTS by the oscillating circuit 38, and the serial data are transmitted to the print head 6a (head unit 10) at the timing synchronized with the serial clock signal CK.

For example, in the case where the interval of the encoder pulse EP is the interval corresponding to 180 dpi and the timing pulse PTS is output at the interval corresponding to 720 dpi, the control unit 35 generates the timing pulse PTS by frequency-multiplying the reception frequency of the encoder pulse EP. For example, as shown in FIG. 5C, when the control unit 35 receives the encoder pulse EP (P2), the control unit 35 acquires the generation period of the timing pulse PTS by changing the interval t1 between the encoder pulse EP (P1) received one period previously and the currently received encoder pulse EP (P2) into ¼ intervals and generates the timing pulse PTS according to the acquired generation period.

When the driving signal generating circuit 39 receives the timing pulse PTS from the control unit 35, the driving signal generating circuit 39 outputs a latch pulse LAT (refer to FIG. 5D) and a driving signal COM (refer to FIG. 5E). The latch pulse LAT and the driving signal COM are transmitted through the internal I/F 36 to the print head 6a. In the print head 6a, the serial data received from the printer controller 30 are latched at the timing based on the latch pulse LAT, and the application or non-application of the driving signal COM to the piezoelectric devices of the nozzles 16 is controlled according to the information (1 or 0) that indicates the ejection or non-ejection of the latched serial data. As a result, the ink ejection from the nozzles 16 of the print head 6a is performed in synchronization with the variation in the transporting speed of the sheet S by the transporting mechanism 5.

The print head 6a prints the user's desired image based on the serial data that are expanded from the printing data on the image forming area A1 of the sheet S. At the same time, the print head 6a prints the reference timing pattern RP that indicates a portion of the ink ejection timing for the image forming area A1 on the margin area A2 in the transport direction. In other words, when the control unit 35 expands the serial data (in the embodiment, the serial data corresponding to the K ink) that are transmitted to the print head 6a, the control unit 35 adds the data for the reference timing pattern RP (the serial data indicating the reference timing pattern RP) for driving a preliminary nozzle 16′ corresponding to the margin area A2. As a result, at the time of the recording operation of the print head 6a, the ink is ejected from the preliminary nozzle 16′ based on the data for the reference timing pattern RP, so that the reference timing pattern RP is formed in the margin area A2.

FIG. 6 exemplarily shows the sheet S where the printing is performed by the print heads 6a to 6d during the transporting thereof by the transporting belt 4 as viewed from the upside. As shown in FIG. 6, the reference timing pattern RP and the checking timing pattern CP are printed on the margin area A2 of the sheet S. In addition, in FIG. 6, the image that is printed on the image forming area A1 by the print heads 6a to 6d is omitted.

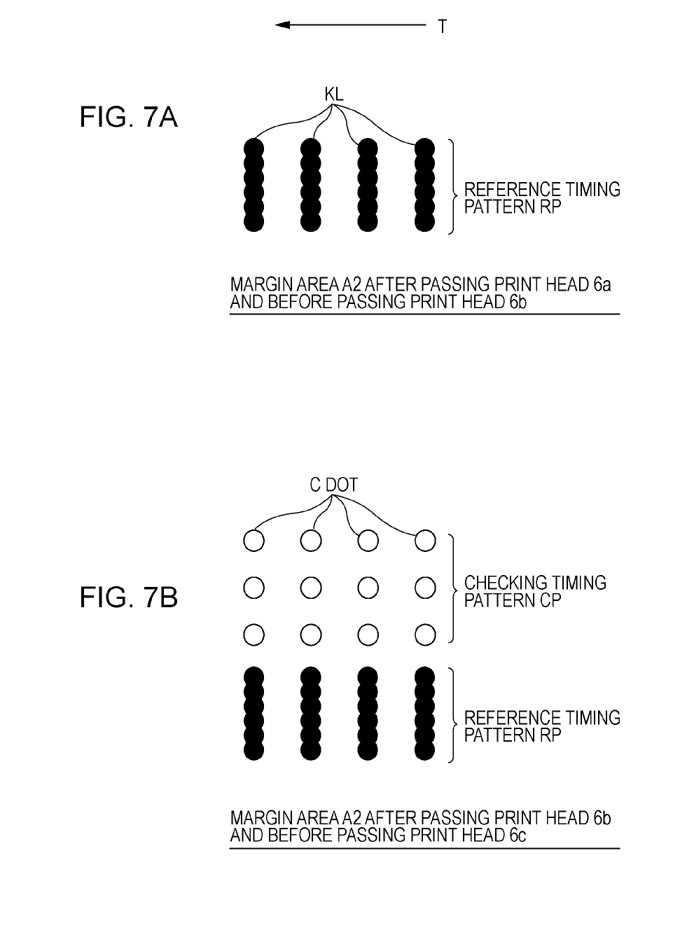

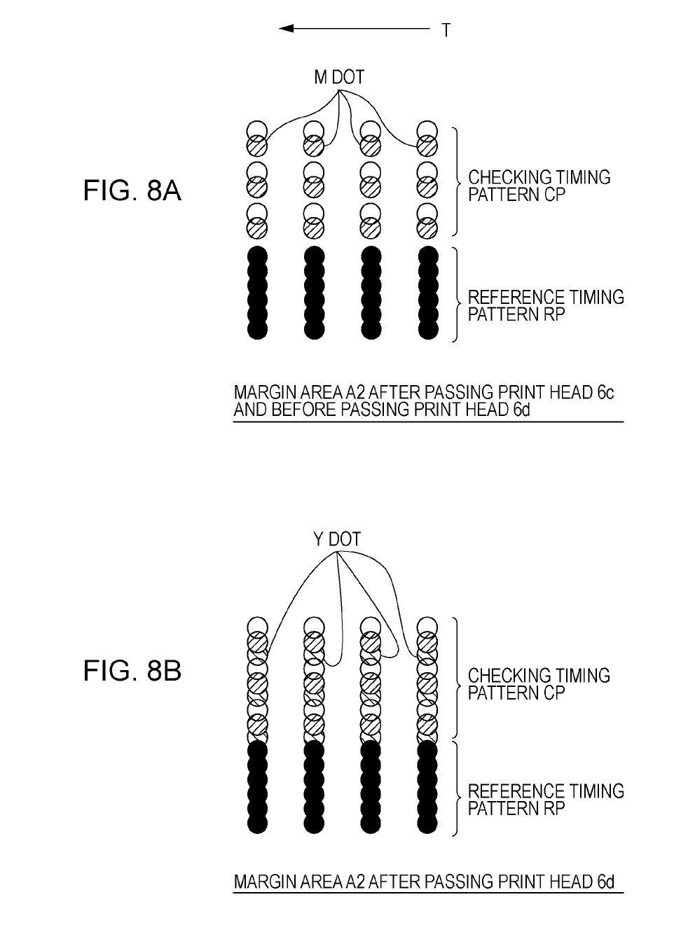

FIGS. 7 and 8 exemplarily show portions of the margin area A2 in the sheet S shown in FIG. 6. FIG. 7A shows a portion of the margin area A2 after passing under the print head 6a. FIG. 7B shows a portion of the margin area A2 after passing under the print head 6b. FIG. 8A shows a portion of the margin area A2 after passing under the print head 6c. FIG. 8B shows a portion of the margin area A2 after passing under the print head 6d. As shown in FIGS. 6 to 8, in the embodiment, as the reference timing pattern RP, a ruled line (referred to as a reference ruled line KL) of the K ink having a predetermined length in the direction (nozzle column alignment direction) substantially perpendicular to the transport direction of the sheet S is printed at an interval in the transport direction.

The formation interval of the reference ruled line KL may be aligned with the forming interval (distance between the slits 8) of the slits 8 of the scale plate. In the above example, the control unit 35 generates the timing pulse PTS at the ¼ period of the generating period of the encoder pulse EP, and when the timing pulse PTS is generated, the driving signal COM is transmitted to the print head 6a. Therefore, the data for the reference timing pattern RP is designed to be the data that permits the application of only the driving signal COM corresponding to an initial timing pulse PTS among four timing pulses PTS that are generated corresponding to the generation of the one encoder pulse EP, so that the reference ruled line KL can be printed at the ¼ printing resolution (once every four pixels) of the transport-direction printing resolution of the print head 6a. Accordingly, the sheet S where the user's desired image and the reference timing pattern RP are printed by the uppermost stream side print head 6a is transferred under the downstream side print heads 6b to 6d.

Next, the control of the ink ejection of the print heads 6b to 6d is described.

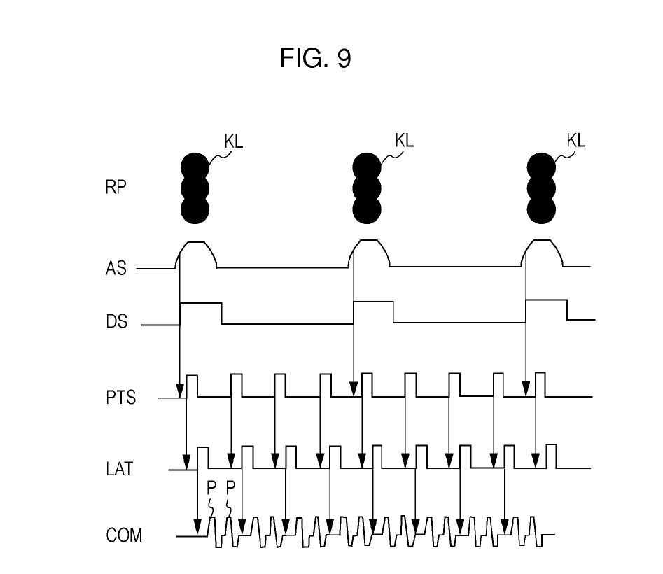

FIG. 9 is a timing chart of the ejection control that is based on the reference timing pattern RP in the print heads 6b to 6d. In the print heads 6b to 6d, the reference timing pattern RP is detected by the photosensors 28b to 28d included in the print heads 6b to 6d. Each of the photosensors 28b to 28d includes a light emitting device and a light receiving device. The light emitting device illuminates light on the paper surface of the sheet S, and the light receiving device receives the reflected light that is reflected on the paper surface. Since the amount of the reflected light from the paper surface is different between the portion where the image is printed and the portion where the image is not printed, the output level of the detection signal from the light receiving device is different between the state where the reference timing pattern RP is illuminated and the state where the reference timing pattern RP is not illuminated. Next, a detection signal AS (refer to FIG. 9B) as an analog data from the light receiving device is A/D-converted to be output as a detection signal DS (refer to FIG. 9C) to the printer controller 30. The printer controller 30 controls the ink ejection timings of the print heads 6b to 6d corresponding to the photosensors 28b to 28d by using the detection signal DS (refer to FIG. 9C) that is acquired based on the detection of the reference timing pattern RP by the photosensors 28b to 28d as a reference.

In other words, the control unit 35 generates the timing pulse PTS (refer to FIG. 9D) based on the detection signal DS similarly to the procedure of generating the timing pulse PTS (refer to FIG. 5C) based on the aforementioned encoder pulse EP (refer to FIG. 5B). In addition, when the driving signal generating circuit 39 receives the timing pulse PTS (refer to FIG. 9D) from the control unit 35, the driving signal generating circuit 39 transmits the latch pulse LAT (refer to FIG. 9E) and the driving signal COM (refer to FIG. 9F) to the print head (any one of the print heads 6b to 6d) corresponding to the photosensor (any one of the photosensors 28b to 28d) that is an output source of the detection signal DS (refer to FIG. 9C) through the internal I/F 36. In this manner, in each of the print heads 6b to 6d, when the reference timing pattern RP is detected by each of the photosensors 28b to 28d thereof, the ink ejection timings of the nozzles 16 are adjusted during the time duration until the next reference timing pattern RP is detected.

Therefore, in the time interval from the time when the previous reference timing pattern RP is detected to the time when the current reference timing pattern RP is detected, in the case where the transporting speed of the sheet S is lower than the original set speed, the ink ejection timing of the nozzles 16 can be delayed. On the contrary, in the case where the transporting speed of the sheet S is higher than the original set speed, the ink ejection timing of the nozzles 16 can be advanced. For this reason, although variation in the speed of the transporting belt 4 occurs, the variation between the landing positions of the ink ejected from the nozzles 16 of the print head 6a and the landing positions of the ink ejected from the nozzles 16 of the print heads 6b to 6d can be prevented.

Although the interval of the reference ruled line KL printed on the margin area A2 can be aligned with the forming interval of the slits 8 as described above, the interval of the reference ruled line KL is not entirely an equally-spaced interval in the actual case. In other words, although the period of the ink ejection for printing the reference ruled line KL is accurately synchronized with the transporting speed of the sheet S, for example, in the case where the flying speed of the ink ejected from each nozzle 16 is constant, the ink landing position in the sheet S infinitesimally varies with the transporting speed. In addition, in the case where the distance from each nozzle 16 to the sheet S is different due to an infinitesimal floating of the sheet S, since a slight abnormality in the ink landing position in the sheet S occurs, the uniformity of the interval of the reference ruled line KL is lost. In the embodiment, by taking into consideration that, strictly speaking, the interval of the reference ruled line KL is not an equally-spaced interval, the reference ruled lines KL passing under the print heads 6b to 6d are detected one by one by the photosensors 28b to 28d, and at the time of each detection, the ink ejection timings of the nozzles 16 of the print heads 6b to 6d are adjusted.

Each of the print heads 6b to 6d prints the user's desired image based on the serial data that are expanded from the printing data on the image forming area A1 of the sheet S. As described above, at the same time, each of the print heads 6b to 6d prints the checking timing pattern CP that indicates a portion of the ink ejection timing for the image forming area A1 on the margin area A2 in the transport direction. In other words, when the control unit 35 expands the serial data (in the embodiment, the serial data corresponding to the C ink, the M ink, and the Y ink) that are transmitted to the print heads 6b to 6d, the control unit 35 adds the data for the checking timing pattern CP (the serial data indicating the checking timing pattern CP) for driving the preliminary nozzle 16′ corresponding to the margin area A2. As a result, at the time of the recording operations of the print heads 6b to 6d, the ink is ejected from the preliminary nozzle 16′ based on the data for the checking timing pattern CP, so that the checking timing pattern CP is formed in the margin area A2.

More specifically, when the printer controller 30 allows the print heads 6b to 6d to print the checking timing pattern CP, the ink is ejected so that the ink landing positions are substantially aligned in the extension lines of the reference ruled lines KL. As understood from the examples of FIGS. 1 and 6, in the printer 1, there are infinitesimal distances between the print heads and the corresponding photosensors (between the print head 6b and the photosensor 28b, between the print head 6c and the photosensor 28c, and between the print head 6d and the photosensor 28d) in the transport direction of the sheet S. Therefore, in order to land ink droplets that constitute the checking timing pattern CP in the extension line of the reference ruled line KL, after the elapse of a time t (time t (several milliseconds) taken for the reference ruled line KL detected by the photosensor to move from the position under the photosensor to the position under the nozzle column of the print head corresponding to the photosensor) from the time when the reference ruled line KL is detected by the photosensor (for example, photosensor 28b), the printer controller 30 needs to allow the nozzles 16 of the print head (print head 6b) corresponding to the photosensor that performs the detection to eject the ink by taking into consideration the infinitesimal distance.

Herein, the distance D between the photosensor and the nozzles of the corresponding print head in the transport direction is known in the design of the printer 1. In addition, since the distance D is short, although there is a variation in the speed of the transporting belt 4 as described above, the variation can be ignored during the time when the transporting belt 4 moves the distance D, so that the speed v of the transporting belt 4 can be treated as a fixed value in the calculation of the time t. Therefore, in the embodiment, the time t is calculated in advance based on the distance D and the speed v as fixed values, and the time t is stored in the ROM 34 or the like of the printer 1. In the case where the reference ruled line KL is detected by a photosensor (the detection signal DS is input from a photosensor), the printer controller 30 generates the timing pulse PTS (refer to FIG. 9D), the latch pulse LAT (refer to FIG. 9E), the driving signal COM (refer to FIG. 9F), and the like, so that the timing of the first ink ejection (after the detection) that is performed by the print head corresponding to the photosensor that performs the detection is disposed after the elapse of the time t from the detection. In addition, similarly to the data for the reference timing pattern RP that is designed to be data that permits the application of only the driving signal COM corresponding to the initial timing pulse PTS among the plurality of the timing pulses PTS that are generated corresponding to the generation of the one encoder pulse EP, the data for the checking timing pattern CP is also designed to be data that permits application of only the driving signal COM corresponding to the initial timing pulse PTS among the same plurality of the timing pulses PTS that are generated corresponding to the one pulse waveform in the detection signals DS (refer to FIG. 9C).

As a result, as shown in FIGS. 6, 7B, and 8, the checking timing pattern CP is printed on the margin area A2 at positions that are substantially aligned to the extension line of the reference ruled line KL. FIG. 7B shows the state that, as the checking timing pattern CP, the C ink droplets (C dots) are formed at a predetermined interval in the direction substantially perpendicular to the transport direction of the sheet S by the print head 6b. In addition, FIG. 8A shows the state where each of the M dots is further formed between the C dots by the print head 6c. FIG. 8B shows the state where each of the Y dots is further formed between the C dots and the M dots by the print head 6d. As a result, the checking timing pattern CP where the dots ejected by the different print heads 6b to 6d are alternately adjacent to each other at the positions substantially aligned with the extension lines of the reference ruled lines KL is formed in the margin area A2 passing through the lowermost stream side print head 6d.

The layout of the checking timing pattern CP that the printer controller 30 controls the print engine 31 to print on the margin area A2 is not limited to the examples shown in FIGS. 6, 7B, and 8.

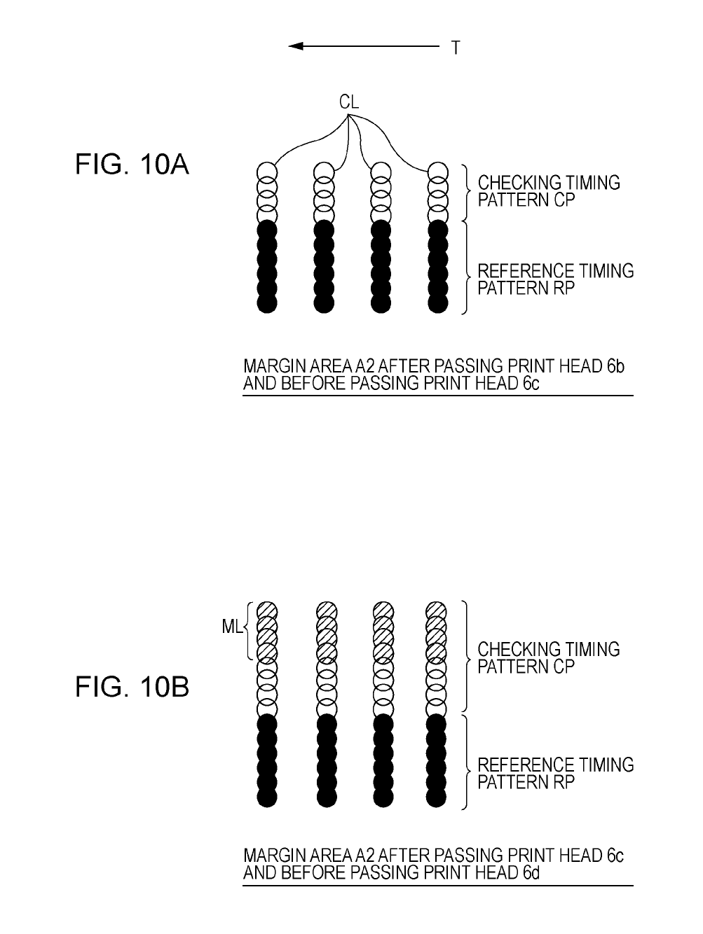

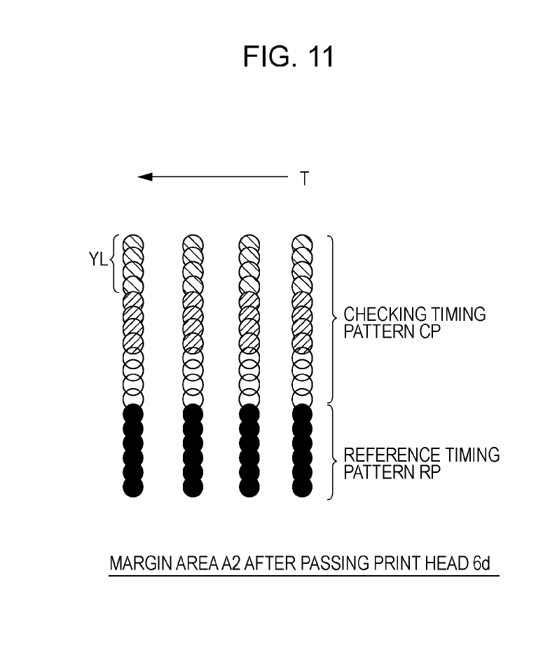

FIGS. 10 and 11 show different examples of the reference timing pattern RP and the checking timing pattern CP that are formed in the margin area A2 in the situations where the sheet S passes under the print heads 6b to 6d. The reference timing patterns RP of FIGS. 10 and 11 are the same as those of FIGS. 7 and 8, but the layouts of the color dots in the checking timing patterns CP are different. FIGS. 10A, 10B, and 11 show a portion of the margin area A2 after passing under the print head 6b, a portion of the margin area A2 after passing under the print head 6c, and a portion of the margin area A2 after passing under the print head 6d, respectively.

FIG. 10A shows the state where checking ruled lines CL, each of which is constructed with a predetermined number of C dots that are continuously formed in the direction substantially perpendicular to the transport direction, are printed to be continuous with the reference ruled lines KL by the print head 6b. In addition, FIG. 10B shows the state where checking ruled lines ML, each of which is constructed with a predetermined number of M dots that are continuously formed in the direction substantially perpendicular to the transport direction, are printed to be continuous with the checking ruled lines CL by the print head 6c. FIG. 11 shows the state where checking ruled lines YL, each of which is constructed with a predetermined number of Y dots that are continuously formed in the direction substantially perpendicular to the transport direction, are printed to be continuous with the checking ruled lines ML by the print head 6d. In other words, according to the examples of FIGS. 10 and 11, the checking timing patterns CP constructed with ink color lines that are continuous with the reference ruled lines KL are printed at the positions substantially aligned with the extension lines of the reference ruled lines KL on the margin area A2 passing through the lowermost stream side print head 6d.

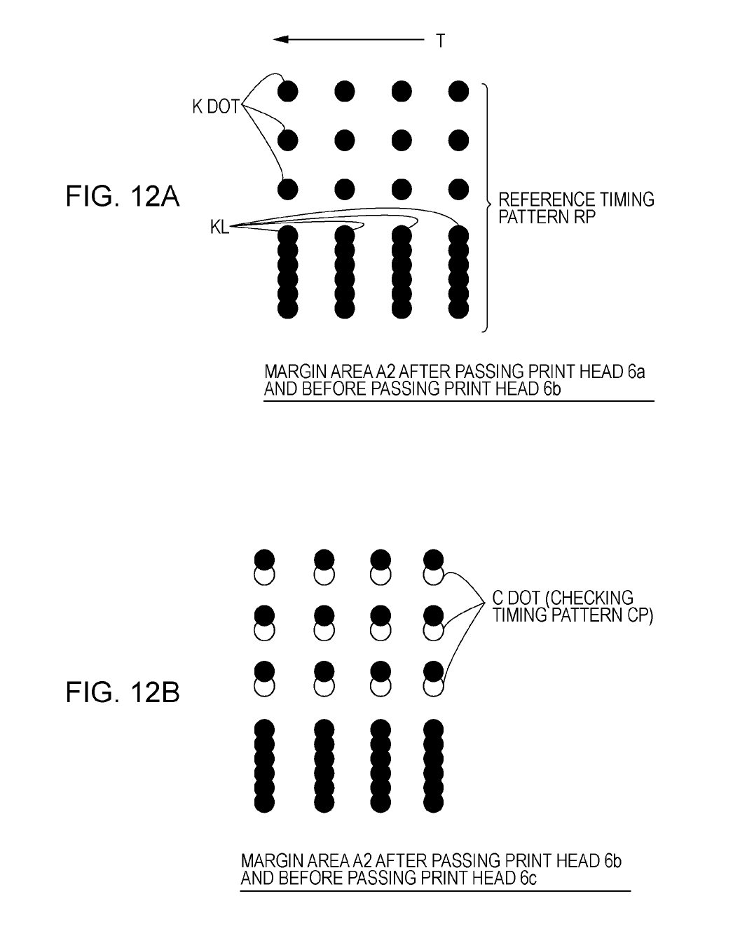

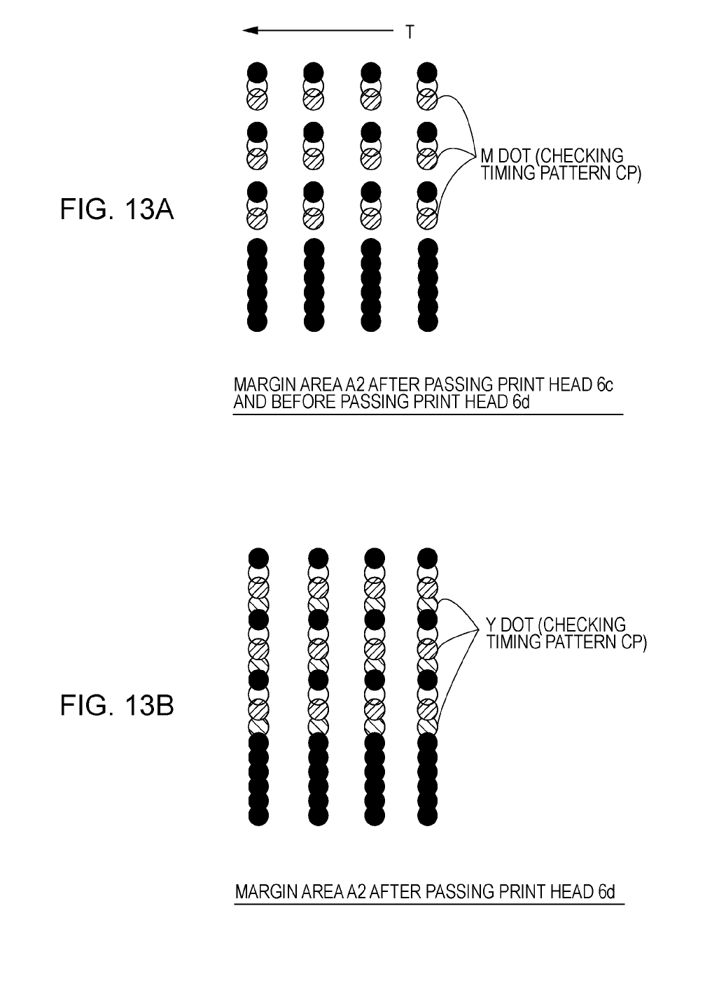

FIGS. 12 and 13 show different examples of the reference timing pattern RP and the checking timing pattern CP that are formed in the margin area A2 in the situations where the sheet S passes under the print heads 6a to 6d. FIGS. 12A, 12B, 13A, and 13B show a portion of the margin area A2 after passing under the print head 6a, a portion of the margin area A2 after passing under the print head 6b, a portion of the margin area A2 after passing under the print head 6c, and a portion of the margin area A2 after passing under the print head 6d, respectively. FIGS. 12 and 13 are the same as FIGS. 7, 8, 10, and 11 in that the reference timing patterns RP include the reference ruled lines KL. However, in the reference timing patterns RP shown in FIGS. 12 and 13, a plurality of K dots that are formed at a predetermined interval are further disposed at positions separated from the reference ruled lines KL in the extension lines of the reference ruled lines KL. In other words, the printer controller 30 allows the print head 6a to print the reference timing pattern RP that is constructed with the jumping K dots and the reference ruled lines KL on the margin area A2.

In addition, in the examples of FIGS. 12 and 13, as the checking timing pattern CP, the printer controller 30 allows the print head 6b to print each of the C dots between the K dots (refer to FIG. 12B), the print head 6c to print each of the M dots between the C dots and the K dots (refer to FIG. 13A), and the print head 6d to print each of the Y dots between the M dots and the K dots (refer to FIG. 13B). In other words, according to the examples of FIGS. 12 and 13, the checking timing pattern CP where the dots ejected by the different print heads 6b to 6d are alternately adjacent to each other in the area between the jumping K dots at the positions substantially aligned with the extension lines of the reference ruled lines KL is printed in the margin area A2 passing through the lowermost stream side print head 6d. In addition, checking ruled lines CL, ML, and YL of the ink colors shown in FIGS. 10 and 11 may be printed in the area between the jumping K dots.

In this manner, in the embodiment, the checking timing patterns CP of the ink colors are printed so as to be aligned with the positions in the extension lines of the reference ruled lines KL as the reference timing patterns RP by the print heads 6b to 6d except for the print head 6a. However, although the printer controller 30 controls the ink ejection of the print heads 6b to 6d so that the positions of the checking timing patterns CP are aligned in the extension lines of the reference ruled line KL in the aforementioned manner, the positions of the checking timing patterns CP may be shifted from the positions of the reference timing patterns RP in reality. These misalignment may be caused by various errors in the printer 1 such as read-out errors of the photosensors 28b to 28d, an infinitesimal variation in the ejection operations of the print heads 6b to 6d, a defective ejection of each nozzle 16, or an infinitesimal error in installation positions of the photosensors 28b to 28d with respect to the print heads 6b to 6d.

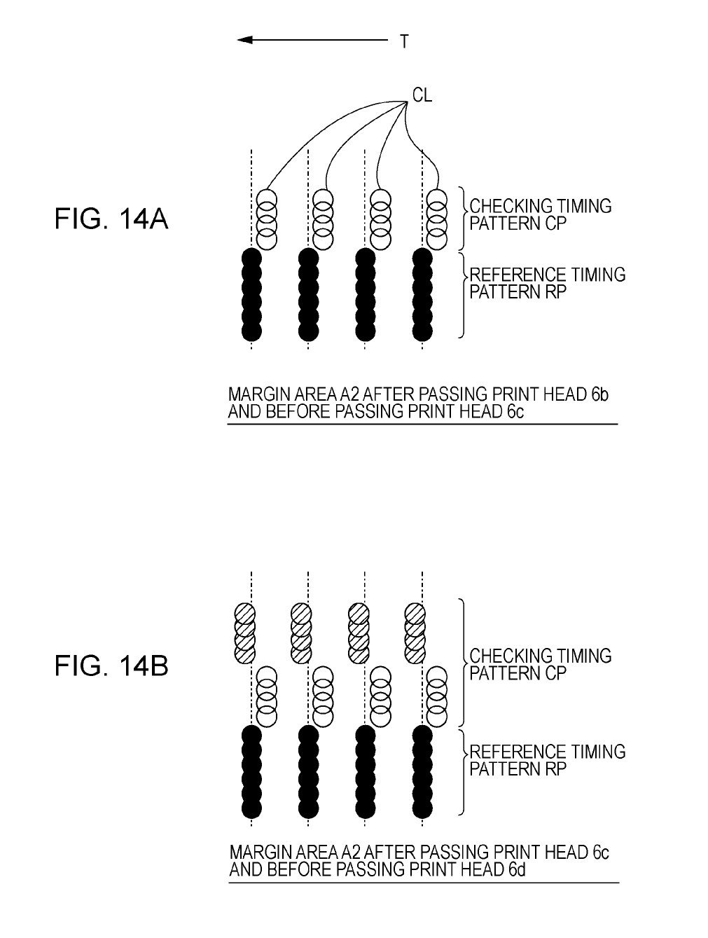

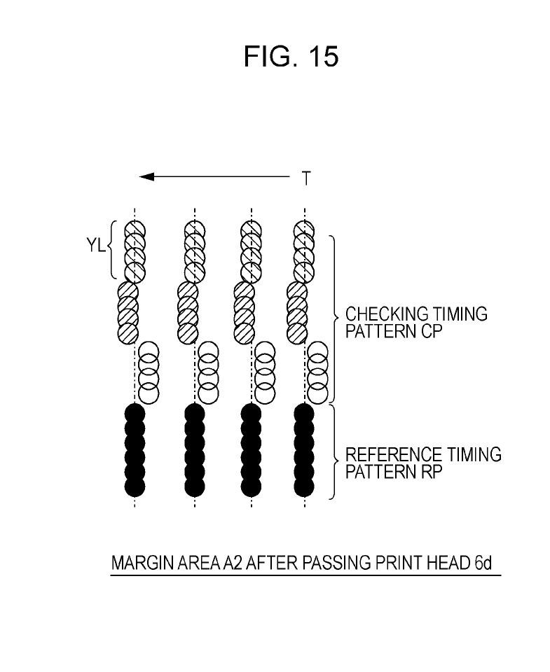

As comparative examples of FIGS. 10 and 11, FIGS. 14 and 15 show the cases where the positions of the reference timing patterns RP and checking timing patterns CP that the printer controller 30 controls the print engine 31 to print on the margin area A2 are shifted from each other. In FIGS. 14 and 15, the checking timing pattern CP (checking ruled line CL) printed by the print head 6b and the checking timing pattern CP (checking ruled line ML) printed by the print head 6c are shifted from the positions in the extension lines of the reference ruled lines KL in the transport direction. The state where the positions of the checking timing pattern CP for some colors (C and M) are shifted may denote that at least the landing positions of the color (C and M) ink ejected on the image forming area A1 at the same time of forming the checking timing pattern CP are shifted from the landing positions of the ink ejected on the image forming area A1 by the uppermost stream side print head 6a. In addition, the degree of shifting of the ink landing positions may denote the degree of quality of the printing result in the image forming area A1.

In this manner, according to the embodiment, in the state where a plurality of the line type print heads corresponding to different ink colors are disposed at a predetermined interval in the transport direction of the sheet S, when the image is printed on the image forming area A1 of the sheet S by performing the ink ejection sequentially from the transport direction upstream side print head, the reference timing pattern RP that indicates the ink ejection timing of the print head 6a is printed on the margin area A2 of the sheet S by the uppermost stream side print head 6a, and the checking timing pattern CP that indicates the ink ejection timings of the print heads 6b to 6d is printed on the margin area A2 by the print heads 6b to 6d.

Accordingly, the user can recognize the detailed results of the ejection control for the print heads 6b to 6d on the basis of the detection of the reference timing pattern RP printed by the print head 6a by observing only the reference timing pattern RP and the checking timing pattern CP on the margin area A2 of the sheet S output from the printer 1. In other words, by observing only the shifting of the checking timing patterns CP of the color inks from the reference timing patterns RP, the user can easily determine at which site in the printed image the shifting occurs, which color is shifted, and how large the degree of shifting is. Therefore, in the case where a printing resultant in which a variation in color is beyond a predetermined allowable range is obtained, the user can make a decision to reject the printing resultant from a to-be-distributed object, or the user can adjust the printer 1 or perform the printing again so as to remove the shifting. In addition, the detection of the shifting of the checking timing pattern CP from the reference timing pattern RP may not be performed by the visual examination by the user, but the automatic detection using an optical sensor, an image processing apparatus, or the like may be performed. In this case, there are advantages in that the entire detection may be efficiently performed and in that the user's burden can be reduced.

In the vicinity of the opening of the nozzle 16, if a time interval when the ink is not ejected is maintained, air comes into contact with the ink inside the nozzle, so that the moisture or solvent in the ink is evaporated. Accordingly, the viscosity of the ink is increased. The increase in the viscosity of the ink may cause various ejection defects such as an abnormal flying speed of the ink droplets ejected from the nozzles, a curve in the flight of the ink droplets, and non-ejection of the ink droplets. Therefore, in the embodiment, before the reference timing pattern RP and the checking timing pattern CP are printed on the margin area A2, the printer controller 30 may allow the preliminary nozzle 16′ that is used to print the reference timing pattern RP or the checking timing pattern CP to perform ink ejection operations multiple times (performing preliminary printing). Due to the preliminary printing, the inks having high viscosity that are accumulated in the vicinity of the opening of the preliminary nozzle 16′ are exhausted, so that the state of defective ejection of the preliminary nozzle 16′ can be resolved. In FIG. 6, an area (preliminary printing area A21) in the front end portion of the sheet S directing the transport direction downstream side in the margin area A2 is exemplified by a dot-dashed line.

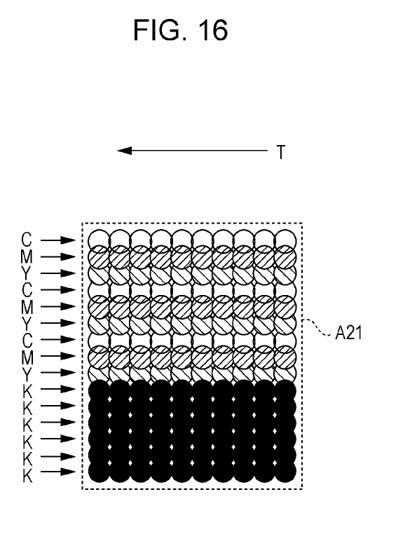

FIG. 16 exemplifies the preliminary printing area A21 that is preliminarily printed by the print heads 6a to 6d. FIG. 16 shows an example where the preliminary printing is performed by the print heads 6a to 6d before the reference timing pattern RP and the checking timing pattern CP are printed by the print heads 6a to 6d as the layout shown in FIGS. 7 and 8. In other words, the printer controller 30 allows the preliminary nozzle 16′ that is used to print the reference timing pattern RP or the checking timing pattern CP to eject the ink when the preliminary printing area A21 passes under the print heads 6a to 6d. As a result, the reference timing pattern RP and the checking timing pattern CP are printed in the state where the ejection defect of the preliminary nozzle 16′ has been resolved, so that the reference timing pattern RP and the checking timing pattern CP that can more accurately indicate the ink ejection timings of the print heads 6a to 6d can be recorded on the margin area A2. In the case where the reference timing pattern RP and the checking timing pattern CP are printed as the layouts shown in FIGS. 10 and 11 or FIGS. 12 and 13, the preliminary printing is performed on the preliminary printing area A21 as the layout shown in FIG. 11 or 13B.

Moreover, the embodiment can be applied to various modified examples as described below.

As described above, the distance D and the speed v are set to fixed values in the calculation of the time t (time taken for the reference ruled line KL detected by the photosensor to move from the position under the photosensor to the position under the nozzle column of the print head corresponding to the photosensor). However, the speed v varies according to the setting (various settings such as rapid, standard, and highly accurate settings) of the printing mode in the printer 1. Therefore, at the time of acquiring the printing data or the like, the printer controller 30 specifies the printing mode that is set by the user and acquires the speed v corresponding to the specified printing mode by referring to a predetermined table defining a correspondence between each printing mode and the speed of the transporting belt 4, which is stored in the ROM 34 or the like in advance. Next, the time t may be calculated by using the acquired speed v and the distance D.

Alternatively, when the reference ruled lines KL are detected by the photosensors 28b to 28d, the printer controller 30 may calculate the time t according to the actual speed of the transporting belt 4. For example, the printer controller 30 sequentially records the history of changes in the rotating speed of the driving motor 7c based on the detection signal DS output from the rotary encoder 9. Next, by referring to the history at the timing when the reference ruled line KL is detected by a photosensor, the average (average speed) of the speeds in the time interval from the current time point to a previous time point by a predetermined time duration prior to the current time point is calculated, and the average speed (or a future speed predicted based on the average speed) is set to the speed v. Next, the time t is calculated based on the distance D and the speed v calculated from the history, and the ink ejection timing of the print head corresponding to the photosensor that detects the reference ruled line KL is adjusted according to the calculated time t. According to the configuration, even in the case where a variation in the speed of the transporting belt 4 is too large to ignore in the movement of the distance D, the variation in the landing position of the ink ejected by each print head can be prevented with high accuracy.

In addition, the print heads 6b to 6d may have a configuration where the distance D is set to substantially 0. For example, in the case where the uppermost stream side print head 6a has a configuration where N head units 10 (first to N-th head units 10) are arrayed in a straight shape in the nozzle column alignment direction, the print heads 6b to 6d at the downstream of the print head 6a are provided with the photosensors 28b to 28d at positions corresponding to a first stage head unit 10 (the first head unit 10) of the print head 6a, and the number of head units 10 is reduced to be lower by one than that of the print head 6a (each of the print heads 6b to 6d is constructed with (N−1) head units 10). According to the configuration, since the reference timing pattern RP that is printed on the margin area A2 by the nozzles 16 of the first head unit 10 of the print head 6a can be detected by the photosensors 28b to 28d provided to the print heads 6b to 6d, the printer controller 30 allows each of the photosensors 28b to 28d to detect the reference timing pattern RP and, at the same time, allows the print heads 6b to 6d corresponding to the photosensors 28b to 28d to eject the ink so that the checking timing pattern CP or the like can be printed. Like this, by setting the distance D to 0, the variation in the landing position of each color ink caused by the occurrence of the distance D can be eliminated.

What is claimed is:

1. A printing apparatus comprising:
a transporting unit that transports a printing medium in a predetermined transport direction;
a print head group having a configuration where a plurality of print heads, each of which has a plurality of ink ejecting nozzles in a range substantially perpendicular to the transport direction including a margin area outside a predetermined image forming area in the printing medium, are disposed at a predetermined interval in the transport direction;
image detection units that are disposed corresponding to the print heads except for at least the uppermost stream side print head in the transport direction among the plurality of the print heads; and
a printing control unit that controls the print heads so that the print heads eject ink on the transported printing medium,
wherein the uppermost stream side print head prints on the margin area a reference timing pattern indicating an ink ejection timing for the image forming area by the uppermost stream side print head, and when an ink ejection timing for the image forming area by the print head corresponding to the image detection unit that detects the reference timing pattern is controlled based on the detection of the reference timing pattern by the image detection unit, the print head corresponding to the image detection unit that performs the detection prints on the margin area a checking timing pattern indicating the ink ejection timing by the print head corresponding to the image detection unit that performs the detection.

2. The printing apparatus according to claim 1, wherein the plurality of the print heads eject different color inks.

3. The printing apparatus according to claim 1, wherein, before the reference timing pattern or the checking timing pattern is printed, each print head performs preliminary printing by ejecting ink on an area in the vicinity of a front end of the printing medium directing the transport direction downstream side in the margin area.

4. The printing apparatus according to claim 1, wherein the uppermost stream side print head prints a ruled line substantially perpendicular to the transport direction at a ratio of one time per predetermined number of pixels as the reference timing pattern, and the print heads except for the uppermost stream side print head eject ink so as for the ink landing positions to be substantially equal to each other in an extension line of the ruled line, so that the checking timing pattern is printed.

5. The printing apparatus according to claim 4, wherein the print heads except for the uppermost stream side print head eject ink at a predetermined interval between the ink droplets ejected by the same print head in the direction substantially perpendicular to the transport direction, so that the checking timing pattern where ink droplets ejected by different print heads are alternately adjacent to each other is printed.

6. The printing apparatus according to claim 4, wherein the print heads except for the uppermost stream side print head eject ink so as for a predetermined number of ink droplets ejected by the same print head to be continuous with each other in the direction substantially perpendicular to the transport direction, so that the checking timing pattern where a plurality of lines formed by ink ejection of the print heads are substantially continuous with each other is printed.

7. The printing apparatus according to claim 4, wherein the ruled line is printed and the reference timing pattern constructed with ink droplets ejected at a predetermined interval is printed at positions separated from the ruled line in the extension line of the ruled line, so that the checking timing pattern is printed in an area between the ink droplets ejected at the predetermined interval.

8. A printing method comprising:
disposing a plurality of print heads, each of which has a plurality of ink ejecting nozzles in a range substantially perpendicular to a transport direction of a printing medium including a margin area outside a predetermined image forming area in the printing medium, at a predetermined interval in the transport direction;
transporting the printing medium in the transport direction; and
ejecting ink on the transported printing medium from the print heads by controlling the print heads,
wherein the uppermost stream side print head prints on the margin area a reference timing pattern indicating an ink ejection timing for the image forming area by the uppermost stream side print head among the plurality of the print heads, and when an ink ejection timing for the image forming area by the print head corresponding to an image detection unit which is disposed corresponding to each of the print heads except for at least the uppermost stream side print head among the plurality of the print heads to detect the reference timing pattern is controlled based on the detection of the reference timing pattern by the image detection unit, the print head corresponding to the image detection unit that performs the detection prints on the margin area a checking timing pattern indicating the ink ejection timing by the print head corresponding to the image detection unit that performs the detection.
